(19) United States
(12) Patent Application Publication
(10) Pub. No.: US 2026/0280896 A1
(43) Pub. Date: Sep. 17, 2026

(54) SYSTEM AND METHOD FOR SECURE DISTRIBUTION OF MACHINE-LEARNING (ML)-BASED MODELS

(71) Applicant: ARIEL SCIENTIFIC INNOVATIONS LTD., Ariel (IL)

(72) Inventor: Ran DUBIN, Ariel (IL)

(21) Appl. No.: 19/554,899

(22) Filed: Mar. 3, 2026

Related U.S. Application Data
(63) Continuation of application No. PCT/IL2024/050883, filed on Sep. 3, 2024.
(60) Provisional application No. 63/536,420, filed on Sep. 3, 2023.

(51) Int. Cl. H04L 9/32; G06N 3/08; H04L 9/08; H04L 9/30

(52) U.S. Cl. CPC H04L 9/3247; G06N 3/08; H04L 9/0825; H04L 9/30; H04L 9/3268

(57) ABSTRACT

The present invention relates generally to the technological field of cyber security. In the general aspect, the invention represents a system and method of secure distribution of ML-based models which provide an improvement of the technological field of cyber security by increasing efficiency of protection from malware delivering via ML-based model distribution, in particular, by providing reliable techniques of delivering pretrained ML-based models to the target user, without being exposed to risks of malware embedding, extraction and execution.

### CROSS-REFERENCE TO RELATED APPLICATIONS

This application is a Continuation patent application of PCT Patent Application No. PCT/IL2024/050883 having International filing date of Sep. 3, 2024, which claims the benefit of priority of U.S. Provisional Patent Application No. 63/536,420, filed Sep. 3, 2023, the contents of which are all incorporated herein by reference in their entirety.

### FIELD OF THE INVENTION

The present invention relates generally to the technological field of cyber security. More specifically, the present invention relates to preventing cyber-attacks caused by delivering malware through machine-learning (ML)-based model distribution.

### BACKGROUND OF THE INVENTION

As known, information technology security or cybersecurity has become an imperative aspect of contemporary computer systems and networks, as they remain vulnerable to cyberattacks.

A cyberattack is a deliberate attempt to access data, functions, or other restricted areas of the system without authorization, potentially with malicious intent. Cyberattacks may be aimed at stealing, altering, or destroying target information by hacking into susceptible systems. As a result of cyberattacks, confidentiality, integrity or availability of target resources may be compromised. Moreover, the damage may extend to resources in addition to the ones initially identified as vulnerable, including, e.g., further resources of the organization that owns the initial resource, and the resources of other involved parties (customers, suppliers). Eventually, cyberattacks have become increasingly sophisticated and dangerous.

Even though many approaches and techniques of cyberattack prevention are known from the prior art nowadays, the technological field of information security remains constantly evolving, struggling to challenge with both rapidly developing malware and new ways of hiding and distributing it.

Over the last years, ML-based model sharing has gained an increased popularity and has become ubiquitous. Unfortunately, it has provoked an increase of cyber-attacks aimed at open-source repositories. The fast adaptation in the industry, lack of awareness and ability to exploit the ML-based models has made them an attractive malware carrier.

Recently, malware was found to be hidden in neural network ML-based models. In most cases, it is done by replacing model weights bits (Least Significant Bits (LSB)) with malware bits using various embedding (inserting) methods. By embedding malware in neurons, the malware can be delivered covertly, with minor or no impact on the performance of neural network. Malware may also be embedded in model metadata, end of file, or may use specific serialization vulnerabilities.

There are efforts to prevent malicious ML-based model spreading known in the art. These efforts are based on scanning ML-based models with open-source malware scanners in order to detect malicious weight serialization and vulnerabilities that can lead to malware code execution when the model is loading. However, such efforts have shown poorly effective results.

### SUMMARY OF THE INVENTION

Accordingly, there is a need for a system and method of secure distribution of ML-based models which would provide an improvement of the technological field of cyber security by increasing efficiency of protection from malware delivering via ML-based model distribution, in particular, by providing reliable techniques of delivering pretrained ML-based models to the target user (target computing device) without being exposed to risks of malware embedding, extraction and execution.

In the general aspect, the invention may be directed to a method of secure distribution of machine-learning (ML)-based models, by at least one processor. The method may include: receiving, by a source computing device, an ML-based model comprising parameter data elements organized according to an original data structure representation; reorganizing, by a source computing device, said parameter data elements, to be organized according to an altered data structure representation; calculating, by a source computing device, a mapping data element, representing a mapping of said parameter data elements between the original and altered data structure representations; transferring, from the source computing device, (i) the mapping data element to an authentication server; and (ii) the altered data structure representation to a target computing device; upon receiving, by the target computing device, the altered data structure representation, transferring, to the authentication server, a request to receive the mapping data element; transferring, from the authentication server to the target computing device, the mapping data element, upon the request; reconstructing, by the target computing device, the original data structure representation, based on the altered data structure representation and the mapping data element, thereby obtaining the ML-based model.

In another general aspect, the invention may be directed to a system for secure distribution of machine-learning (ML)-based models, wherein the system may include at least one non-transitory memory device, wherein modules of instruction code are stored, and at least one processor associated with said at least one memory device, and configured to execute the modules of instruction code, whereupon execution of said modules of instruction code, the at least one processor is configured to: receive, by a source computing device, an ML-based model comprising parameter data elements organized according to an original data structure representation; reorganize, by a source computing device, said parameter data elements, to be organized according to an altered data structure representation; calculate, by a source computing device, a mapping data element, representing a mapping of said parameter data elements between the original and altered data structure representations; transfer, from the source computing device, (i) the mapping data element to an authentication server; and (ii) the altered data structure representation to a target computing device; upon receiving, by the target computing device, the altered data structure representation, transfer, to the authentication server, a request to receive the mapping data element; transfer, from the authentication server to the target computing device, the mapping data element, upon the request; reconstruct, by the target computing device, the original data structure representation, based on the altered data structure representation and the mapping data element, thereby obtaining the ML-based model.

In some embodiments, the ML-based model may be an artificial neural network (ANN), and said parameter data elements may represent weight and bias coefficients. Said original data structure representation may be defined by at least one of: (i) a number of layers in the ANN; (ii) a number of node data elements in at least one layer of the ANN; (iii) an association of said weight and bias coefficients with respective node data elements of the ANN.

In some embodiments, the method may further include generating, by the source computing device, a digital signature of the mapping data element; transferring, from the source computing device to the authentication server, the digital signature of the mapping data element; and verifying, by the authentication server, the digital signature of the mapping data element.

In some embodiments, the method may further include generating, by the source computing device, a digital signature of the mapping data element, using a private key of the source computing device; transferring, from the source computing device to the authentication server, the digital signature of the mapping data element and a public key certificate of the source computing device; validating, by the authentication server, the public key certificate of the source computing device; extracting, by the authentication server, a public key of the source computing device from the public key certificate of the source computing device; and verifying, by the authentication server, the digital signature of the mapping data element, using the public key of the source computing device.

In some embodiments, the method may further include generating, by the source computing device, a digital signature of the altered data structure representation; transferring, from the source computing device to the target computing device, the digital signature of the altered data structure representation; and verifying, by the target computing device, the digital signature of the altered data structure representation.

In some embodiments, the method may further include generating, by the source computing device, a digital signature of the altered data structure representation, using a private key of the source computing device; transferring, from the source computing device to the target computing device, the digital signature of the altered data structure representation and a public key certificate of the source computing device; transferring, from the authentication server to the target computing device, a public key of the authentication server; validating, by the target computing device, the public key certificate of the source computing device, using the public key of the authentication server; extracting, by the target computing device, a public key of the source computing device from the public key certificate of the source computing device; and verifying, by the target computing device, the digital signature of the altered data structure representation, using the public key of the source computing device.

In some embodiments, the method may further include transferring, by the source computing device to the authentication server the digital signature of the altered data structure representation in association with the mapping data element; wherein transferring, by the target computing device to the authentication server, the request comprises indicating the digital signature of the altered data structure representation; and wherein transferring, from the authentication server to the target computing device, the mapping data element comprises selecting the mapping data element, based on the association with the digital signature of the altered data structure representation.

In some embodiments, the method may further include generating, by the source computing device, a unique identifier, based on the altered data structure representation; transferring, by the source computing device to the authentication server, the unique identifier in association with the mapping data element; and generating, by the target computing device, the unique identifier, based on the altered data structure representation; wherein transferring, by the target computing device to the authentication server, the request comprises indicating the unique identifier; and wherein transferring, from the authentication server to the target computing device, the mapping data element comprises selecting the mapping data element, based on the association with the unique identifier.

In some embodiments, the unique identifier may represent a hash value of the altered data structure representation.

In some embodiments, the method may further include training the ML-based model, by the source computing device, wherein said training may include adjusting values of said parameter data elements.

In some embodiments, said training may be performed within a secure environment.

In some embodiments, said altered data structure representation may be generated randomly.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for secure distribution of ML-based models, according to some embodiments;

FIG. 2A is a block diagram, depicting, in detail, a source computing device of a system for secure distribution of ML-based models, according to some embodiments;

FIG. 2B is a block diagram, depicting, in detail, an authentication server of the system for secure distribution of ML-based models, according to some embodiments;

FIG. 2C is a block diagram, depicting, in detail, a target computing device of the system for secure distribution of ML-based models, according to some embodiments;

FIG. 3 is a flow diagram, depicting a method for secure distribution of ML-based models, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, “choosing”, “selecting”, “omitting”, “training” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

It shall be understood that, in the context of the present description, terms “signature”, “certificate”, “certification authority”, “private/public key” and the like pertain to the technological field of digital cryptography (e.g., to known and ubiquitously used standards like X.509), and, furthermore, these terms would be easily recognized by the person skilled in the art as technical.

Unless explicitly stated, the method embodiments described herein are not constrained to a particular order or sequence. Additionally, some of the described method embodiments or elements thereof can occur or be performed simultaneously, at the same point in time, concurrently, or iteratively and repeatedly.

In embodiments of the present invention, some steps of the claimed method may be performed using machine-learning (ML)-based models or may include actions performed on ML-based models, e.g., transferring ML-based models over a computer network. ML-based models may be configured or “trained” for a specific task, e.g., classification or regression.

In some embodiments, ML-based models may be artificial neural networks (ANN).

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

It should be obvious for the one ordinarily skilled in the art that various ML-based models can be implemented without departing from the essence of the present invention. It should also be understood, that in some embodiments ML-based model may be a single ML-based model or a set (ensemble) of ML-based models realizing as a whole the same function as a single one. Hence, in view of the scope of the present invention, the abovementioned variants should be considered equivalent.

As known, embedding malware in ML-based models is usually performed using various steganography, cryptography, and model serialization malware attack techniques, rendering most malware detection tools ineffective.

The present invention provides a solution to the problems of the prior art by applying a “moving target defense” paradigm. “Moving target” is an idea that originally grew out of the success of attackers utilizing techniques to continuously alter their attack profiles to avoid detection and became a known software defense approach. As a defense technique, “moving target defense” approach suggests making a software object that is subjected to cyberattacks (or its serialization in memory) dynamically changing, thereby representing it as a “moving target” that is “hard to hit”. If inject malware in such dynamic object, due to its constant alteration, it is impossible or almost impossible to extract and execute the injected malware, making the injection (the embedding) harmless.

In particular, it is suggested herein to reorganize (preferably randomly), prior to a distribution, an original data structure of an ML-based model, e.g., mesh an association of weight and bias coefficients with respective node data elements of an ANN structure of the ML-based model, reorganize layers of the ANN structure etc. It is further suggested to create a mapping data element, representing a mapping of parameters between the original and altered data structure representation. The target user may receive the altered data structure representation (or, in other words, ML-based model in the altered data structure representation), e.g., directly from a provider or via a “model zoo”—open repository for sharing ML-based models. Then the target user may request the authentication server to provide the mapping data element and reconstruct the original data structure representation, using the received mapping data element and the altered data structure representation, thereby obtaining the ML-based model. In the distribution process, said authentication server acts as a third-party authorizing side, ensuring secure transferring of all the essential data to the target user, e.g., by applying various public-key encryption techniques, digital signatures and certificates.

Thereby, the present invention provides reliable techniques of delivering pretrained ML-based models to the target user, without exposing them to risks of malware embedding, extraction and execution.

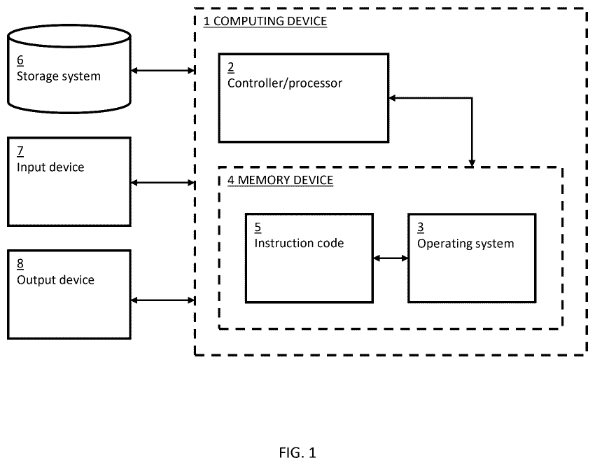

Reference is now made to FIG. 1, which is a block diagram depicting a computing device, which may be included within an embodiment of the system for secure distribution of ML-based models, according to some embodiments.

Computing device 1 may include a processor or controller 2 that may be, for example, a central processing unit (CPU) processor, a chip or any suitable computing or computational device, an operating system 3, a memory device 4, instruction code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to instruction code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory device 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory device 4 may be or may include a plurality of possibly different memory units. Memory device 4 may be a computer or processor non-transitory readable medium, or a computer non-transitory storage medium, e.g., a RAM. In one embodiment, a non-transitory storage medium such as memory device 4, a hard disk drive, another storage device, etc. may store instructions or code which when executed by a processor may cause the processor to carry out methods as described herein.

Instruction code 5 may be any executable code, e.g., an application, a program, a process, task, or script. Instruction code 5 may be executed by processor or controller 2 possibly under control of operating system 3. For example, instruction code 5 may be a standalone application or an API module that may be configured to reorganize parameter data elements of an ML-based model, to be organized according to an altered data structure representation; calculate a mapping data element; reconstruct the original data structure representation, based on the altered data structure representation and the mapping data element, as further described herein. Although, for the sake of clarity, a single item of instruction code 5 is shown in FIG. 1, a system according to some embodiments of the invention may include a plurality of executable code segments or modules similar to instruction code 5 that may be loaded into memory device 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Various types of input and output data may be stored in storage system 6 and may be loaded from storage system 6 into memory device 4 where it may be processed by processor or controller 2. In some embodiments, some of the components shown in FIG. 1 may be omitted. For example, memory device 4 may be a non-volatile memory having the storage capacity of storage system 6. Accordingly, although shown as a separate component, storage system 6 may be embedded or included in memory device 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

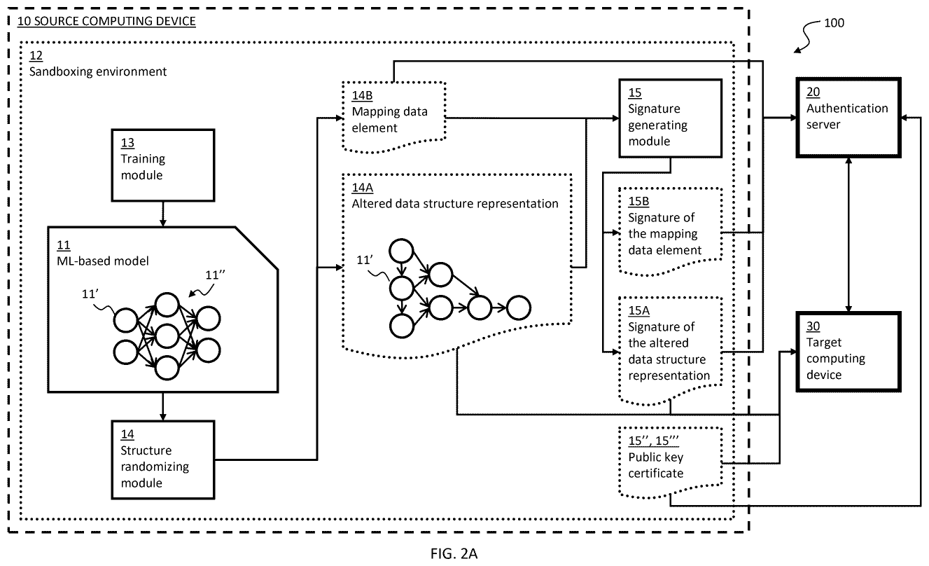

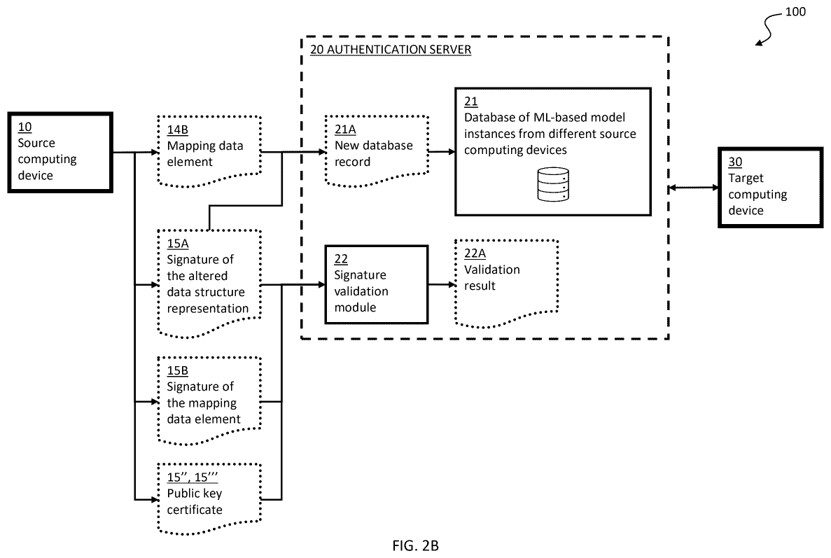

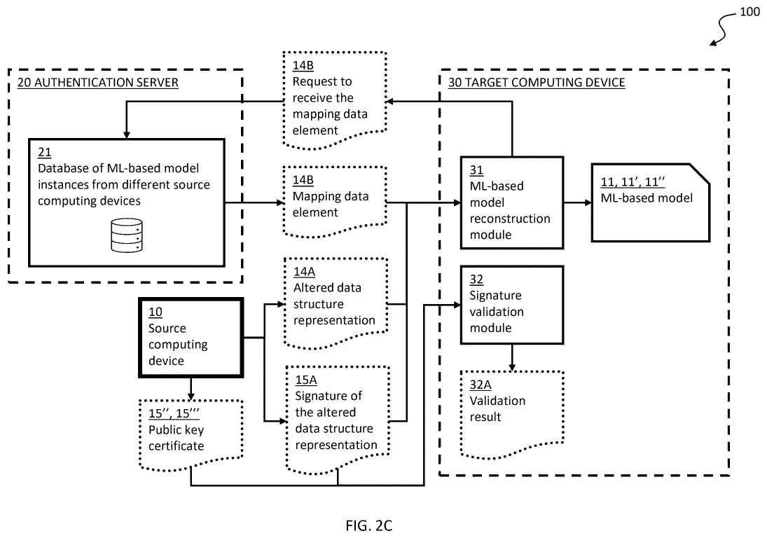

Reference is now made to FIGS. 2A-2C complementary depicting various aspects of system 100 for secure distribution of ML-based models, according to some embodiments.

According to some embodiments of the invention, system 100 may be implemented as a software module, a hardware module, or any combination thereof. For example, system 100 may be or may include computing devices such as element 1 of FIG. 1. Furthermore, system 100 may be adapted to execute one or more modules of instruction code (e.g., element 5 of FIG. 1) to request, receive, analyze, calculate and produce various data.

As further described in detail herein, system 100 may be adapted to execute one or more modules of instruction code (e.g., element 5 of FIG. 1) in order to perform steps of the claimed method.

As shown in FIGS. 2A-2C, arrows may represent flow of one or more data elements to and from system 100 and/or among modules or elements of system 100. Some arrows have been omitted in FIGS. 2A-2C for the purpose of clarity.

In some embodiments, system 100 may include source computing device 10 (from which the distribution of ML-based model (e.g., ML-based model 11) is performed), authentication server 20 and target computing device 30 (to which the ML-based model (e.g., ML-based model 11) must be delivered).

In some embodiments said computing devices 10, 30 and server 20 may be connected via computer network interface, e.g., using internet communication protocols. It shall be understood that, according to various embodiments of the present invention, a division between devices 10, 20 and 30 may be physical, virtual, or combined.

Referring now to FIG. 2A, source computing device 10 is represented in detail.

In some embodiments, source computing device 10 may include sandboxing environment 12 for secure training of ML-based model 11. Sandboxing environment 12 (also known as “enclave”) may be a software, hardware or combined solution, e.g., involving various virtualization techniques, that provides an isolated environment within the memory of source computing device 10 where ML-based model 11 may be trained without being exposed to any malware-related risks. Using environment 12 is important, since the method is mainly directed to the process of transferring ML-based model 11 from source computing device 10 to target computing device 30, therefore, it must be guaranteed that ML-based model 11 was not affected by malware prior to being transferred.

In some embodiments, source computing device 10 may further include training module 13, located within said sandboxing environment 12. Training module 13 may be configured to perform training of ML-based model 11. ML based model 11 may include parameter data elements 11′ organized according to original data structure representation 11″. Said training may include adjusting values of said parameter data elements 11′.

In some embodiments, ML-based model 11 may be an artificial neural network (ANN), wherein said parameter data elements 11′ may represent weight and bias coefficients; and wherein said original data structure representation 11″ may be defined by at least one of: (i) a number of layers in the ANN; (ii) a number of node data elements in at least one layer of the ANN; (iii) an association of said weight and bias coefficients with respective node data elements of the ANN.

In some embodiments, source computing device 10 may further include structure randomizing module 14. Structure randomizing module 14 may be configured to reorganize said parameter data elements 11′, to be organized according to altered data structure representation 14A. In some embodiments, structure randomizing module 14 may generate altered data structure representation 14A randomly. In some embodiments, structure randomizing module 14 may be located within sandboxing environment 12.

In some embodiments, structure randomizing module 14 may be further configured to calculate mapping data element 14B, representing a mapping of said parameter data elements 11′ between original and altered data structure representations 11A″ and 14A, respectively.

For example, structure randomizing module 14, may assign index to each weight and bias coefficient, indicating which node data elements they are associated with. Structure randomizing module 14 may create a “de-shuffle” list (e.g., mapping data element 14B), indicating the correct associations of node data elements with weight and bias coefficients. Structure randomizing module 14 may then generate a random “shuffle” list, including random associations of node data elements with weight and bias coefficients, and apply shuffle list to reorganize the structure of ML-based model 11. At the next stage, structure randomizing module 14 may shuffle layers of ML-based model 11 in the same manner and update the “de-shuffle” list (e.g., mapping data element 14B) with information about the correct order and content of layers.

Source computing device 10 may be further configured to transfer altered data structure representation 14A and mapping data element 14B to signature generating module 15.

Signature generating module 15 may be configured to generate digital signature 15A of altered data structure representation 14A, using private key 15′ of source computing device 10. Signature generating module 15 may be further configured to generate digital signature 15B of mapping data element 14B, using private key 15′ of source computing device 10. In some embodiments, signature generating module 15 may apply known algorithms, such as SHA-256 and RSA to generate signatures 15A and 15B. In some embodiments, signature generating module 15 may be located within sandboxing environment 12.

In some embodiments, a pair of private key 15′ and public key 15″ of source computing device 10 may be issued by authentication server 20, e.g., at the preceding stage wherein source computing device 10 registration in system 100 is performed. This way, authentication server 20 may act as a third-party trusted entity, checking whether the source computing device 10 is indeed a trusted source (i.e., checking whether this source is registered in system 100).

In some embodiments, source computing device 10 may be further configured to transfer, to authentication server 20: (i) mapping data element 14B; (ii) digital signature 15B of mapping data element 14B; (iii) public key 15″ certificate 15′″ of source computing device 10; (iv) digital signature 15A of altered data structure representation 14A in association with mapping data element 14B (meaning that authentication server 20 may store mapping data element 14B and digital signature 15A together, “knowing” that they correspond to each other).

In some embodiments, source computing device 10 may be further configured to transfer, to target computing device 30: (i) altered data structure representation 14A; (ii) digital signature 15A of altered data structure representation 14A and public key 15″ certificate 15′″ of source computing device 10.

Referring now to FIG. 2B, authentication server 20 of system 100 for secure distribution of ML-based models (e.g., ML-based model 11) is described, according to some embodiments.

In some embodiments, authentication server 20 may include database 21 of ML-based model instances received from different computing devices (such as source computing device 10) and stored for further distribution. In some embodiments, authentication server 20 may form a new database record 21A for database 21, record 21A including (i) signature 15A of altered data structure representation 14A; and (ii) respective mapping data element 14B.

In the illustrated embodiments, authentication server 20 acts as a certification authority (CA) and provides public key certificates (such as certificate 15′″) to source computing devices (such as device 10). However, it shall be understood that the present invention is not limited in this regard, and separate entity may act as a CA.

In some embodiments, authentication server 20 may include signature validation module 22.

Signature validation module 22 may be configured to validate public key 15″ certificate 15′″ of source computing device 10. E.g., signature validation module 22 may validate certificate 15′″ using public key 22′ of authentication server 20. It shall be understood that, in such an example, asymmetric encryption algorithms are used, meaning that certificate 15′″ may be signed using private key 22″ of authentication server 20 and, for validation, public key 22′ of authentication server 20 may be used. However, in alternative embodiments, symmetric encryption may be applied, meaning that certificate 15′″ may be signed using private key 22″ and the same key 22″ may be used to validate the signature.

In some embodiments, signature validation module 22 may be further configured to extract, after validating certificate 15′″, public key 15″ of source computing device 10 from public key 15″ certificate 15′″ of source computing device 10. Signature validation module 22 may be further configured to verify digital signature 15B of mapping data element 14B, using extracted public key 15″.

Signature validation module 22 may be further configured to output certificate 15′″ validation and digital signature 15B verification result (e.g., as a result 22A data element). Authentication server 20 may be further configured to transfer verification result 22A data element back to source computing device 10, to inform device 10 about the results of the validation/verification procedure.

Referring now to FIG. 2C, target computing device 30 of system 100 for secure distribution of ML-based models (e.g., ML-based model 11) is described, according to some embodiments.

In some embodiments, target computing device 30 may include ML-based model reconstruction module 31 and signature validation module 32.

In some embodiments, signature validation module 32 may be configured to request, from authentication server 20, public key 22′ of authentication server 20, either upon receiving altered data structure representation 14A and signature 15A of altered data structure representation 14A from source computing device 10, or at the preceding stage, when registering target computing device 30 in system 100.

In some embodiments, authentication server 20 may be further configured to transfer, to target computing device 30, public key 22′ of authentication server 20, upon the request.

In some embodiments, signature validation module 32 may be configured to validate public key 15″ certificate 15′″ of source computing device 10, using received public key 22′ of authentication server 20. Signature validation module 32 may be further configured to extract, after said validation, public key 15″ of source computing device 10 from public key 15″ certificate 15′″ of source computing device 10. Signature validation module 32 may be further configured to verify digital signature 15A of altered data structure representation 14A, using public key 15″ of source computing device 10.

Signature validation module 32 may be further configured to output result 32A data element, indicating the result of public key 15″ certificate 15′″ validation and digital signature 15A verification. Target computing device 30 may be further configured to transfer result 32A data element back to source computing device 10, to inform device 10 about the results of the validation/verification procedure.

In some embodiments, ML-based model reconstruction module 31 may be configured to transfer, to authentication server 20, a request to receive mapping data element 14B, upon receiving, by target computing device 30, altered data structure representation 14A and, in some embodiments, after performing the above-described public key 15″ certificate 15′″ validation and digital signature 15A verification (and if the result 32A of it is positive). In some embodiments, ML-based model reconstruction module 31 may be further configured to indicate, in said request, digital signature 15A of altered data structure representation 14A.

In some embodiments, authentication server 20 may be further configured to select, from database 21, mapping data element 14B, based on its association with digital signature 15A of altered data structure representation 14A, upon the request. Authentication server 20 may be further configured to transfer, to ML-based model reconstruction module 31, mapping data element 14B.

In some alternative embodiments, instead of using the association of mapping data element 14B with digital signature 15A of altered data structure representation 14A, in order to select the desired mapping data element 14B, a separate identifier may be applied. In particular, in some alternative embodiments, structure randomizing module 14 may be further configured to generate unique identifier (not shown in figures), based on altered data structure representation 14A (e.g., by applying various known hashing algorithms). Hence, in some embodiments, said unique identifier may represent a hash value of altered data structure representation 14A. Source computing device 10 may be further configured to transfer, to authentication server 20, said unique identifier in association with mapping data element 14B. Target computing device 30 may be further configured to generate said unique identifier, based on altered data structure representation 14A by applying same algorithms (e.g., known hashing algorithms) thereto, as were applied by source computing device 10 for the same task. It shall be understood that such algorithms shall be known and shared between the entities of system 100 (e.g., between devices 10 and 30). Target computing device 30 may be further configured to indicate said unique identifier within the request to authentication server 20 to receive mapping data element 14B. Authentication server 20 may be further configured to select mapping data element 14B from database 21, based on its association with the unique identifier.

ML-based model reconstruction module 31 may be further configured to reconstruct original data structure representation 11″, based on altered data structure representation 14A and mapping data element 14B, thereby obtaining ML-based model 11. E.g., Module 31 may use said “de-shuffle” list of mapping data element 14B, where the correct associations of node data elements with indexed weight and bias coefficients (parameter data elements 11′) are listed, to rearrange ML-based model 11 layers to be represented in the original order and reassign weight and bias coefficients to achieve correct node data elements within each layer.

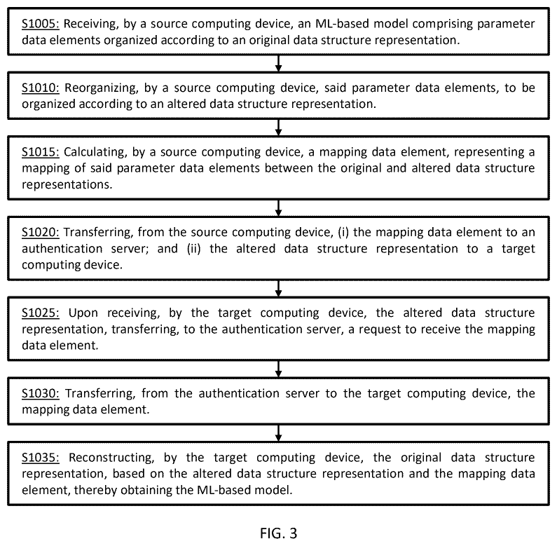

Referring now to FIG. 3, a flow diagram is presented, depicting a method for secure distribution of ML-based models (e.g., ML-based model 11), by at least one processor (e.g., processor 2 of FIG. 1), according to some embodiments.

As shown in step S1005, the at least one processor (e.g., such as processor 2 of FIG. 1, e.g., of a source computing device (e.g., source computing device 10, as shown in FIG. 2A)) may receive an ML-based model (e.g., ML-based model 11, as shown in FIG. 2A) comprising parameter data elements (e.g., parameter data elements 11′, as shown in FIG. 2A) organized according to an original data structure representation (e.g., original data structure representation 11″, as shown in FIG. 2A). Step S1005 may be carried out by sandboxing environment 12 and training module 13 (as described with reference to FIG. 2A).

As shown in step S1010, the at least one processor (e.g., such as processor 2 of FIG. 1, e.g., of a source computing device (e.g., source computing device 10, as shown in FIG. 2A)) may reorganize said parameter data elements (e.g., parameter data elements 11′, as shown in FIG. 2A), to be organized according to an altered data structure representation (e.g., altered data structure representation 14A, as shown in FIG. 2A). Step S1010 may be carried out by structure randomizing module 14 (as described with reference to FIG. 2A).

As shown in step S1015, the at least one processor (e.g., such as processor 2 of FIG. 1, e.g., of a source computing device (e.g., source computing device 10, as shown in FIG. 2A)) may calculate a mapping data element (e.g., mapping data element 14B, as shown in FIG. 2A), representing a mapping of said parameter data elements (e.g., parameter data elements 11′, as shown in FIG. 2A) between the original and altered data structure representations (e.g., original data structure representation 11″ and altered data structure representation 14A, as shown in FIG. 2A). Step S1015 may be carried out by structure randomizing module 14 (as described with reference to FIG. 2A).

As shown in step S1020, the at least one processor (e.g., such as processor 2 of FIG. 1, e.g., of a source computing device (e.g., source computing device 10, as shown in FIG. 2A)) may transfer, from the source computing device (e.g., source computing device 10, as shown in FIG. 2A), (i) the mapping data element (e.g., mapping data element 14B, as shown in FIG. 2A) to an authentication server (e.g., authentication server 20, as shown in FIGS. 2A-2C); and (ii) the altered data structure representation (e.g., altered data structure representation 14A, as shown in FIG. 2A) to a target computing device (e.g., target computing device 30, as shown in FIGS. 2A-2C). Step S1020 may be carried out by source computing device 10 (as described with reference to FIG. 2A).

As shown in step S1025, the at least one processor (e.g., such as processor 2 of FIG. 1, e.g., of a target computing device (e.g., target computing device 30, as shown in FIG. 2C)) may transfer, to the authentication server (e.g., authentication server 20, as shown in FIG. 2B), upon receiving the altered data structure representation (e.g., altered data structure representation 14A, as shown in FIG. 2A), a request to receive the mapping data element (e.g., mapping data element 14B, as shown in FIG. 2A). Step S1025 may be carried out by ML-based model reconstruction module 31 (as described with reference to FIG. 2C).

As shown in step S1030, the at least one processor (e.g., such as processor 2 of FIG. 1, e.g., of the authentication server (e.g., authentication server 20, as shown in FIGS. 2A-2C)) may transfer, to the target computing device (e.g., target computing device 30, as shown in FIG. 2C), the mapping data element (e.g., mapping data element 14B, as shown in FIG. 2A). Step S1030 may be carried out by authentication server 20 (as described with reference to FIGS. 2B-2C).

As shown in step S1035, the at least one processor (e.g., such as processor 2 of FIG. 1, e.g., of a target computing device (e.g., target computing device 30, as shown in FIG. 2C)) may reconstruct the original data structure representation (e.g., original data structure representation 11″, as shown in FIGS. 2A-2C), based on the altered data structure representation (e.g., altered data structure representation 14A, as shown in FIGS. 2A-2C) and the mapping data element (e.g., mapping data element 14B, as shown in FIGS. 2A-2C), thereby obtaining the ML-based model (e.g., ML-based model 11, as shown in FIGS. 2A-2C). Step S1035 may be carried out by ML-based model reconstruction module 31 (as described with reference to FIG. 2C).

As can be seen from the provided description, the claimed invention represents a system and method of secure distribution of ML-based models which provide an improvement of the technological field of cyber security by increasing efficiency of protection from malware delivering via ML-based model distribution, in particular, by providing reliable techniques of delivering pretrained ML-based models to the target user (target computing device), without being exposed to risks of malware embedding, extraction and execution.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of secure distribution of machine-learning (ML)-based models, by at least one processor, the method comprising:
receiving, by a source computing device, an ML-based model comprising parameter data elements organized according to an original data structure representation;
reorganizing, by a source computing device, said parameter data elements, to be organized according to an altered data structure representation;
calculating, by a source computing device, a mapping data element, representing a mapping of said parameter data elements between the original and altered data structure representations;
transferring, from the source computing device, (i) the mapping data element to an authentication server; and (ii) the altered data structure representation to a target computing device;
upon receiving, by the target computing device, the altered data structure representation, transferring, to the authentication server, a request to receive the mapping data element;
transferring, from the authentication server to the target computing device, the mapping data element, upon the request;
reconstructing, by the target computing device, the original data structure representation, based on the altered data structure representation and the mapping data element, thereby obtaining the ML-based model.

2. The method of claim 1, wherein the ML-based model is an artificial neural network (ANN), wherein said parameter data elements represent weight and bias coefficients;
and wherein said original data structure representation is defined by at least one of: (i) a number of layers in the ANN; (ii) a number of node data elements in at least one layer of the ANN; (iii) an association of said weight and bias coefficients with respective node data elements of the ANN.

3. The method of claim 1, further comprising:
generating, by the source computing device, a digital signature of the mapping data element;
transferring, from the source computing device to the authentication server, the digital signature of the mapping data element; and
verifying, by the authentication server, the digital signature of the mapping data element.

4. The method of claim 1, further comprising:
generating, by the source computing device, a digital signature of the mapping data element, using a private key of the source computing device;
transferring, from the source computing device to the authentication server, the digital signature of the mapping data element and a public key certificate of the source computing device;
validating, by the authentication server, the public key certificate of the source computing device;
extracting, by the authentication server, a public key of the source computing device from the public key certificate of the source computing device; and
verifying, by the authentication server, the digital signature of the mapping data element, using the public key of the source computing device.

5. The method of claim 1, further comprising:
generating, by the source computing device, a digital signature of the altered data structure representation;
transferring, from the source computing device to the target computing device, the digital signature of the altered data structure representation; and
verifying, by the target computing device, the digital signature of the altered data structure representation.

6. The method of claim 1, further comprising:
generating, by the source computing device, a digital signature of the altered data structure representation, using a private key of the source computing device;
transferring, from the source computing device to the target computing device, the digital signature of the altered data structure representation and a public key certificate of the source computing device;
transferring, from the authentication server to the target computing device, a public key of the authentication server;
validating, by the target computing device, the public key certificate of the source computing device, using the public key of the authentication server;
extracting, by the target computing device, a public key of the source computing device from the public key certificate of the source computing device; and
verifying, by the target computing device, the digital signature of the altered data structure representation, using the public key of the source computing device.

7. The method of claim 6, further comprising:
transferring, by the source computing device to the authentication server the digital signature of the altered data structure representation in association with the mapping data element;
wherein transferring, by the target computing device to the authentication server, the request comprises indicating the digital signature of the altered data structure representation; and
wherein transferring, from the authentication server to the target computing device, the mapping data element comprises selecting the mapping data element, based on the association with the digital signature of the altered data structure representation.

8. The method of claim 1, further comprising:
generating, by the source computing device, a unique identifier, based on the altered data structure representation;
transferring, by the source computing device to the authentication server, the unique identifier in association with the mapping data element; and
generating, by the target computing device, the unique identifier, based on the altered data structure representation;
wherein transferring, by the target computing device to the authentication server, the request comprises indicating the unique identifier; and
wherein transferring, from the authentication server to the target computing device, the mapping data element comprises selecting the mapping data element, based on the association with the unique identifier.

9. The method of claim 8, wherein the unique identifier represents a hash value of the altered data structure representation.

10. The method of claim 1, further comprising training the ML-based model, by the source computing device, wherein said training includes adjusting values of said parameter data elements.

11. The method of claim 10, wherein said training is performed within a secure environment.

12. The method of claim 1, wherein said altered data structure representation is generated randomly.

13. A system for secure distribution of machine-learning (ML)-based models, the system comprising: at least one non-transitory memory device, wherein modules of instruction code are stored, and at least one processor associated with said at least one memory device, and configured to execute the modules of instruction code, whereupon execution of said modules of instruction code, the at least one processor is configured to:
receive, by a source computing device, an ML-based model comprising parameter data elements organized according to an original data structure representation;
reorganize, by a source computing device, said parameter data elements, to be organized according to an altered data structure representation;
calculate, by a source computing device, a mapping data element, representing a mapping of said parameter data elements between the original and altered data structure representations;
transfer, from the source computing device, (i) the mapping data element to an authentication server; and (ii) the altered data structure representation to a target computing device;
upon receiving, by the target computing device, the altered data structure representation, transfer, to the authentication server, a request to receive the mapping data element;
transfer, from the authentication server to the target computing device, the mapping data element, upon the request;
reconstruct, by the target computing device, the original data structure representation, based on the altered data structure representation and the mapping data element, thereby obtaining the ML-based model.

14. The system of claim 13, wherein the ML-based model is an artificial neural network (ANN), wherein said parameter data elements represent weight and bias coefficients;
and wherein said original data structure representation is defined by at least one of: (i) a number of layers in the ANN; (ii) a number of node data elements in at least one layer of the ANN; (iii) an association of said weight and bias coefficients with respective node data elements of the ANN.

15. The system of claim 13, wherein the at least one processor is further configured to:
generate, by the source computing device, a digital signature of the mapping data element;
transfer, from the source computing device to the authentication server, the digital signature of the mapping data element; and
verify, by the authentication server, the digital signature of the mapping data element.

16. The system of claim 13, wherein the at least one processor is further configured to:
generate, by the source computing device, a digital signature of the mapping data element, using a private key of the source computing device;
transfer, from the source computing device to the authentication server, the digital signature of the mapping data element and a public key certificate of the source computing device;
validate, by the authentication server, the public key certificate of the source computing device;
extract, by the authentication server, a public key of the source computing device from the public key certificate of the source computing device; and
verify, by the authentication server, the digital signature of the mapping data element, using the public key of the source computing device.

17. The system of claim 13, wherein the at least one processor is further configured to:
generate, by the source computing device, a digital signature of the altered data structure representation;
transfer, from the source computing device to the target computing device, the digital signature of the altered data structure representation; and
verify, by the target computing device, the digital signature of the altered data structure representation.

18. The system of claim 13, wherein the at least one processor is further configured to:
generate, by the source computing device, a digital signature of the altered data structure representation, using a private key of the source computing device;
transfer, from the source computing device to the target computing device, the digital signature of the altered data structure representation and a public key certificate of the source computing device;
transfer, from the authentication server to the target computing device, a public key of the authentication server;
validate, by the target computing device, the public key certificate of the source computing device, using the public key of the authentication server;
extract, by the target computing device, a public key of the source computing device from the public key certificate of the source computing device; and
verify, by the target computing device, the digital signature of the altered data structure representation, using the public key of the source computing device.

19. The system of claim 18, wherein the at least one processor is further configured to:
transfer, by the source computing device to the authentication server the digital signature of the altered data structure representation in association with the mapping data element;
wherein transferring, by the target computing device to the authentication server, the request comprises indicating the digital signature of the altered data structure representation; and
wherein transferring, from the authentication server to the target computing device, the mapping data element comprises selecting the mapping data element, based on the association with the digital signature of the altered data structure representation.

20. The system of claim 13, wherein the at least one processor is further configured to:
generate, by the source computing device, a unique identifier, based on the altered data structure representation;
transfer, by the source computing device to the authentication server, the unique identifier in association with the mapping data element; and
generate, by the target computing device, the unique identifier, based on the altered data structure representation;
wherein transferring, by the target computing device to the authentication server, the request comprises indicating the unique identifier; and
wherein transferring, from the authentication server to the target computing device, the mapping data element comprises selecting the mapping data element, based on the association with the unique identifier.
